(19) United States
(12) Patent Application Publication
(10) Pub. No.: US 2014/0000465 A1
(43) Pub. Date: Jan. 2, 2014

(54) ELECTRONIC DEVICE AND EMBOSSING METHOD OF ELECTRONIC DEVICE

(71) Applicant: JENG-CHE CHEN, Tu-Cheng (TW)

(72) Inventor: JENG-CHE CHEN, Tu-Cheng (TW)

(73) Assignee: HON HAI PRECISION INDUSTRY CO., LTD., Tu-Cheng (TW)

(21) Appl. No.: 13/596,166

(22) Filed: Aug. 28, 2012

(30) Foreign Application Priority Data
Jun. 27, 2012 (TW) 101123104

(51) Int. Cl. B31F 1/07; B41F 9/02

(52) U.S. Cl. 101/32; 101/153

(57) ABSTRACT

An electronic device includes an enclosure, a driving device attached to the enclosure, a first rotating member, and a second rotating member. The first rotating member includes a relief member. The second rotating member includes an intaglio member corresponding to the relief member. The first rotating member and the second rotating member are attached to the driving device and can be rotated by the driving device, to move a paper between the first rotating member and a second rotating member. The relief member is engaged with the intaglio member to emboss a pattern on the paper.

### BACKGROUND

1. Technical Field

The present disclosure relates to electronic devices and methods of the electronic devices, more particularly to an electronic device for embossing a pattern to a paper and an embossing method of the electronic device.

2. Description of Related Art

Electronic devices, such as printers or photocopiers are commonly used in an office. Generally, an embossing device is manually operated when a pattern is to be embossed on a piece of paper. However, it manually embossing each piece of paper is laborious and time-consuming . Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway view of an electronic device in accordance with an embodiment.

FIG. 2 is an exploded, cutaway view of an electronic device in accordance with another embodiment.

FIG. 3 is an assembled view of the electronic device of FIG. 1.

FIG. 4 is similar to FIG. 3, and a piece of paper has embossed by the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

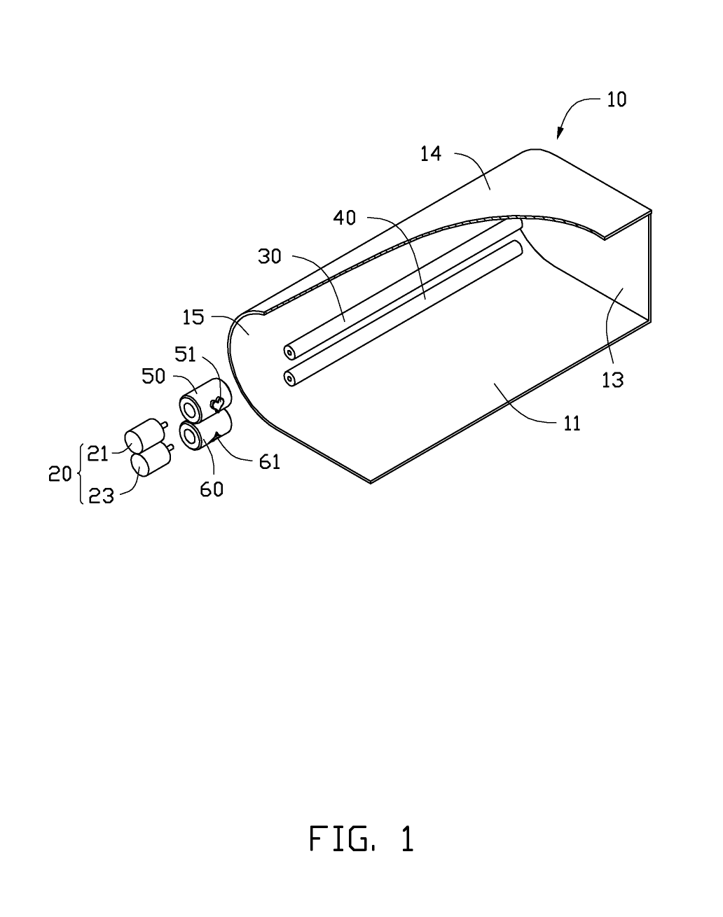

FIG. 1 illustrates an electronic device in accordance with an embodiment. The electronic device includes an enclosure 10, a driving device 20, a first rotating member 30, a second rotating member 40, a first roll 50 attached to the first rotating member 30, and a second roll 60 attached to the second rotating member 40. In one embodiment, the electronic device can be secured to a printer or a photocopier by known means, such as screws.

The enclosure 10 includes a bottom plate 11, two opposite side plates 13 (only one is shown in FIGS. 1-4) extending from two opposite edges of the bottom plate 11, a top plate 14, and a connecting plate 15 connected to the bottom plate 11 and the top plate 14. In one embodiment, the connecting plate 15 is substantially arcuate, and the top plate 14 is substantially parallel to the bottom plate 11.

The driving device 20 includes a first driving member 21 and a second driving member 23. The first driving member 21 is attached to the first rotating member 30, and the second driving member 23 is attached to the second rotating member 40. In one embodiment, the first driving member 21 and the second driving member 23 are motors. The present disclosure is not limited to such a configuration and the positions thereof can be changed according to other known techniques to allow movement of the driving device 20. For example, the driving device 20 can include a motor (not shown) and two driving gears (not shown) connected to the motor. A first engaging gear (not shown) is located on the first driving member 21, to mesh with a first one of the two driving gears. A second engaging gear (not shown) is located on the second driving member 23, to mesh with a second one of the two driving gears.

The first roll 50 defines at least one relief member 51, and the second roll 60 defines at least one intaglio member 61 corresponding to the relief member 51. In one embodiment, the relief member 51 can be a graph, a character, or a picture, etc..

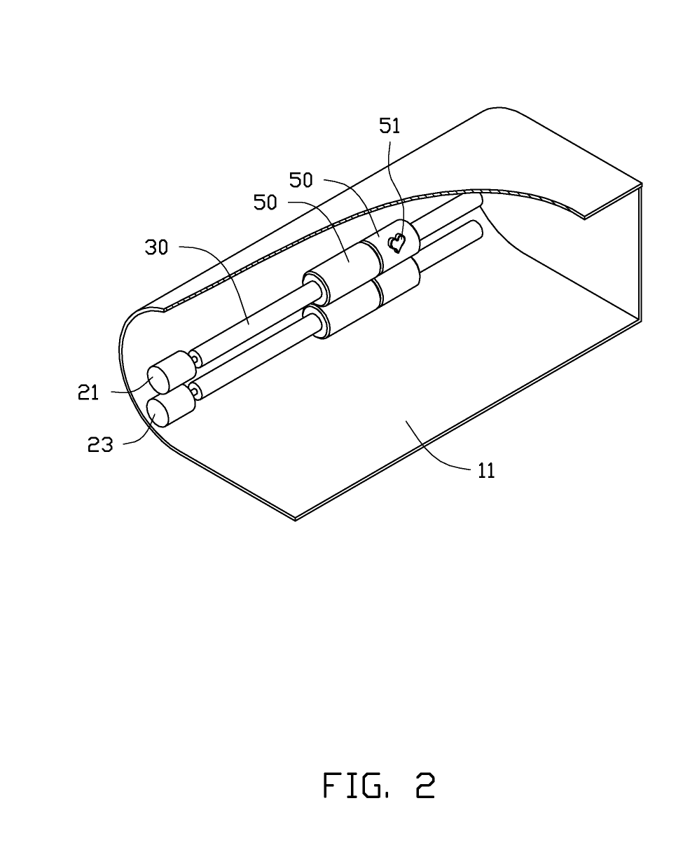

FIG. 2 illustrates an electronic device in accordance with another embodiment. The electronic device includes two of the first rolls 50 aligned together and two second rolls 60 aligned together. Therefore, the relief member 51 can be a combination of at least two of the graph, the character, the picture, and the character, such as a combination of a graph and a character, or a combination of a graph and a picture, or a combination of a character and a picture, or a combination of a graph, a character and a picture. In one embodiment, the relief member 51 can be defined in one of the first roll 50, or defined in two or more of the first rolls 50.

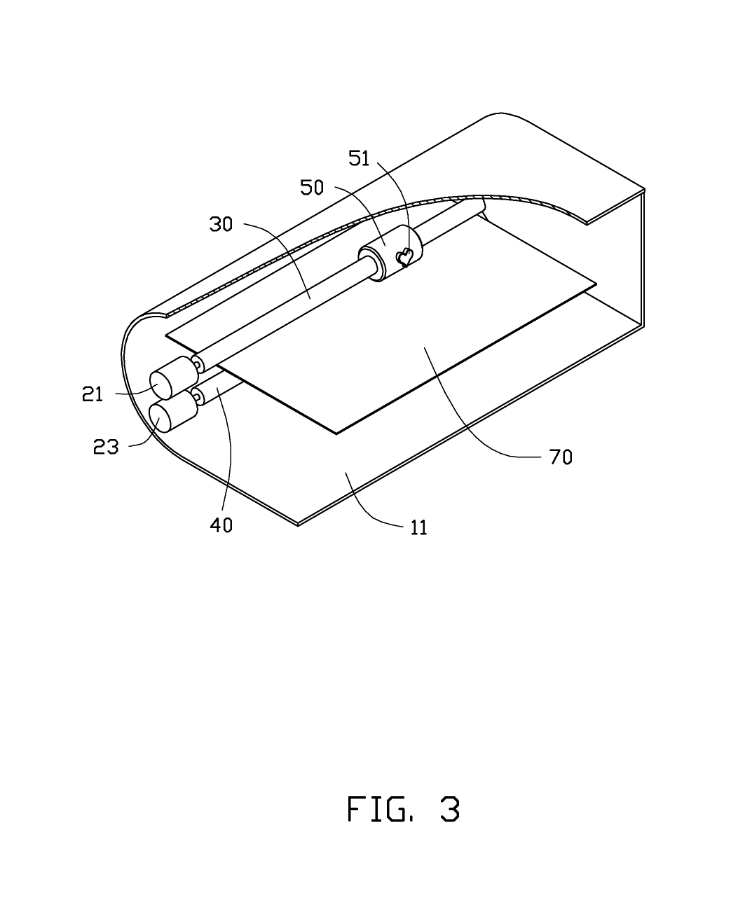

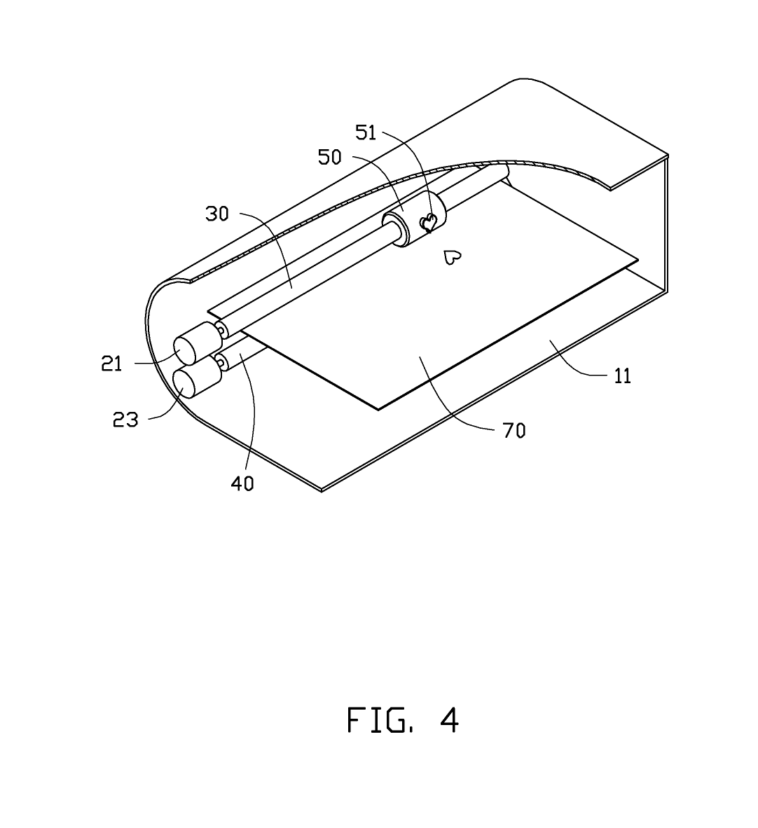

FIGS. 3-4 illustrate an assembled view of the electronic device in accordance with another embodiment. In assembly, the first roll 50 is sleeved on the first rotating member 30, and the second roll 60 is sleeved on the second rotating member 40. The first driving member 21 is secured to an end of the first rotating member 30, and the second driving member 23 is secured to an end of the second rotating member 40. The first driving member 21 and the second driving member 23 are secured to each of the two side plates 13 by known means, such as screws, or clamps. The first rotating member 30 is substantially parallel to the second rotating member 40 and the bottom plate 11. In a first position, the relief member 51 is pointed at the top plate 14 and away from the second rotating member 40, and the intaglio member 61 is pointed at the bottom plate 11 and away from the first rotating member 30.

In use, a paper feeding device (not shown) of a printer feeds a piece of paper 70 between the first rotating member 30 and the second rotating member 40. The first driving member 21 starts to rotate the first rotating member 30 in a clockwise direction.

Simultaneously, the second driving member 23 starts to rotate the second rotating member 40 in a counterclockwise direction. Thus, the first rotating member 30 and the second rotating member 40 together move the piece of paper 70 in a first direction near to the connecting plate 15, until the relief member 51 is aligned with the intaglio member 61, to emboss the pattern on the pieces of papers 70. Then, the first driving member 21 rotates the first rotating member 30 in a counterclockwise direction, and the second driving member 23 rotates the second rotating member 40 in a clockwise direction. Thus, the first rotating member 30 and the second rotating member 40 together move the piece of paper 70 in a second direction that is away from the connecting plate 15, until the piece of paper 70 is sent into the paper feeding device. Then, the first driving member 21 and the second driving member 23 stop to wait for embossing the next piece of paper 70.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
an enclosure;
a driving device attached to the enclosure;
a first rotating member comprising a relief member; and
a second rotating member comprising a intaglio member corresponding to the relief member; and each of the first rotating member and the second rotating member being attached to the driving device,
wherein the first rotating member and the second rotating member are rotated by the driving device to move a piece of paper between the first rotating member and a second rotating member, and the relief member is engaged with the intaglio member to emboss a pattern on the piece of paper.

2. The electronic device of claim 1, wherein when the first rotating member is rotated in a first direction, the second rotating member is rotated in a second direction opposite to the first direction.

3. The electronic device of claim 1, further comprising at lease one first roll on the first rotating member, wherein the relief member is defined in the at least one first roll.

4. The electronic device of claim 3, wherein a number of the at least one first roll is two, and the relief member is defined in each of the two first rolls.

5. The electronic device of claim 1, wherein the enclosure comprises a bottom plate, and the first rotating member is substantially parallel to each of the second rotating member and the bottom plate.

6. The electronic device of claim 1, wherein the driving device comprises a first driving member and a second driving member, the first driving member is attached to the first rotating member, and the second driving member is attached to the second rotating member.

7. The electronic device of claim 1, wherein the relief member comprises a graph, a character, a picture, or a combination of at least two of the graph, the character, the picture, and the character.

8. An electronic device comprising:
an enclosure comprising a bottom plate and a top plate substantially parallel to the bottom plate;
a driving device attached to the enclosure;
a first rotating member comprising a relief member; and
a second rotating member comprising a intaglio member corresponding to the relief member; and each of the first rotating member and the second rotating member being attached to the driving device,
wherein the first rotating member and the second rotating member are rotatable between a first position and a second position; in the first position, the relief member is towards the top plate and away from the bottom plate, and the intaglio member is towards the bottom plate and away from the top plate, so that the intaglio member is separated from the relief member; in the second position, the relief member is towards the bottom plate, and the intaglio member is towards the top plate, so that the relief member abuts the intaglio member.

9. The electronic device of claim 8, wherein when the first rotating member is rotated in a first direction, the second rotating member is rotated in a second direction opposite to the first direction.

10. The electronic device of claim 8, further comprising at lease one first roll on the first rotating member, wherein the relief member is defined in the at least one first roll.

11. The electronic device of claim 10, wherein a number of the at least one first roll is two, and the relief member is defined in each of the two first rolls.

12. The electronic device of claim 8, wherein the first rotating member is substantially parallel to each of the second rotating member and the bottom plate.

13. The electronic device of claim 8, wherein the driving device comprises a first driving member and a second driving member, the first driving member is attached to the first rotating member, and the second driving member is attached to the second rotating member.

14. The electronic device of claim 8, wherein the relief member comprises a graph, a character, or a picture.

15. The electronic device of claim 8, wherein the relief member comprises a combination of at least two of the graph, the character, the picture, and the character.

16. An embossing method comprising:
feeding a piece of paper between a first rotating member and a second rotating member by a paper feeding device;
rotating the first rotating member and the second rotating member;
aligning a relief member with an intaglio member by rotating the first rotating member and the second rotating member with the piece of paper between the first rotating member and the second rotating member;
embossing a pattern on the piece of paper; and
rotating the first rotating member and the second rotating member to send the piece of paper to the paper feeding device.

17. The embossing method of claim 16, wherein the step of rotating the first rotating member and the second rotating member comprises rotating the first rotating member in a first direction, and rotating the second rotating member in a second direction opposite to the first direction.

18. The embossing method of claim 16, wherein the step of aligning the relief member with the intaglio member comprises rotating the first rotating member in a clockwise, and rotating the second rotating member in a counterclockwise; and the step of rotating the first rotating member and the second rotating member to send the piece of paper to the paper feeding device comprises rotating the first rotating member in a counterclockwise direction, and rotating the second rotating member in a clockwise direction.
